(19) United States
(12) Patent Application Publication
(10) Pub. No.: US 2014/0114790 A1
(43) Pub. Date: Apr. 24, 2014

(54) Method of Auctioning a Digital Multimedia Interactive Session

(71) Applicant: Adekunle Ayodele, Snellville, GA (US)

(72) Inventor: Adekunle Ayodele, Snellville, GA (US)

(21) Appl. No.: 14/057,987

(22) Filed: Oct. 18, 2013

Related U.S. Application Data
(63) Continuation-in-part of application No. 14/057,936, filed on Oct. 18, 2013.
(60) Provisional application No. 61/716,538, filed on Oct. 21, 2012.

(51) Int. Cl. G06Q 30/08

(52) U.S. Cl. CPC G06Q 30/08
USPC 705/26.3

(57) ABSTRACT

The present invention is a method of auctioning a digital multimedia interactive session between a celebrity and a system user. Both the celebrity and the user are members of a digital community such as a social network, though they may have different types of member accounts. Celebrities are required to record a live video during the account generation process and this video is reviewed by system administrators to parse out persons purporting to be celebrities, but aren't. Upon successful vetting, the celebrity then establishes a desired time, date, and topic for a digital multimedia interactive session, culminating in the submission of a request to the system. The request is reviewed and approved by the system administrators who launch an auction on a website. Users can bid in the auction up until the predetermined close date. Auction winners of the auction are provided the opportunity to interact with the celebrity.

### CROSS REFERENCE TO RELATED APPLICATION

This application claims the benefit of U.S. Provisional Application No. 61/716,538 filed on Oct. 21, 2012. This application is a continuation in part of application Ser. No. 14/057,936 filed on Oct. 18, 2013. The patent applications identified above are incorporated here by reference in its entirety to provide continuity of disclosure.

### BACKGROUND OF THE INVENTION

1. Field of the Invention

The present invention relates to a method of auctioning a digital interactive chat session. More specifically, it relates to a method of auctioning a chat session with a famous or notable figure and protecting the integrity of the chat session by vetting the account of the famous figure prior to establishing the chat session.

Celebrities and famous figures sometimes donate their time to charity by allowing the auction of their participation in an activity. The activity in which the celebrity will participate is usually determined by the celebrity and the charity before auctioning begins. Sometimes a date and time for the activity may also be established before the beginning of the auction. Luncheons, prom attendance, and private musical performances are examples of the types of activities donated by celebrities for charitable auctions. Once an activity is agreed upon, the charity establishes an auction and advertises the activity as the item up for bids. The winner of the auction is then contacted by the charity, which informs her of the particulars of the activity and any limitations on her participation. In this way, people can gain access to their favorite celebrities, and charities receive a sizeable donation.

This activity auction model works effectively in physical, real world settings, but does not translate well to online scenarios. A primary reason for this lack of portability is difficulty associated with confirming celebrity identity. In a physical setting, the charity has the contact information of the celebrity and likely, has interacted with the celebrity in person or via telephone. Additionally, the auction winner has an in person interaction with the celebrity and can personally compare the countenance, vocal tones, and mannerism of the celebrity against their memory of the individual. These options are not available in an online setting, because the charity may have no prior access to the celebrity prior to the commission of the online activity.

Current online auction houses are not equipped to handle celebrity activity auctions, because they do not offer vetting of sellers, or auctioned services. Whether for liability reasons or lack of human resources, auction houses do not check services or their sellers for legitimacy prior to the launch of an auction. Auctions that are discovered to be fraudulent may be rescinded, and the winning bidder refunded, but this action is not preventative. Thus, a sophisticated conman or one who bears a close resemblance to a famous figure can fraudulently auction off activities with themselves, while pretending to be the celebrity.

A method of safely auctioning online activities with celebrities is needed in the art. The present invention provides such a method by requiring celebrities to record a live capture video and communicate with a system administrator in order to confirm their identity prior to establishing an auction.

2. Description of the Prior Art

The present method of auctioning a multimedia interactive session with a famous figure contains steps not disclosed in the prior art. The method includes the steps of performing a review of an account created by a celebrity prior to launch of an auction for an activity with the celebrity. The method also includes a review of the account of the winning bidder, to reduce the risk of fraudulent accounts created to harass celebrity participants. The prior art does not disclose these steps of vetting and checking both the celebrity and the participant to reduce fraud and improve systemic integrity. The following is a list of prior art systems and methods deemed relevant to the present disclosure.

Quay, U.S. Patent Publication No. 2002/0059132 discloses a system and method of online bidding for a service contract. The system and method provides computer facilitated biding for contracts, and enables companies soliciting services to efficiently obtain bids from service providers without individually soliciting same. By way of example, a clinical study supporter can post a proposal to the system, and request bids from interested clinical facilities. Unlike the present invention, Quay does not disclose any form of vetting or review of participants prior to bidding, nor does it provide the ability for interested participants to bid on an interaction with a provider.

Henley, U.S. Pat. No. 8,396,783 teaches a system and method of providing means for acquisition of medical services. The system is a bidding platform that enables persons to bid on medical services. Potential patients can designate how much they are willing to pay for particular medical services or consulting by proffering bids through the system. Though the Henley system and method does provide bidding by persons who wish to purchase a service rather than by service providers bidding for jobs, it does not disclose the review and approval of participants prior to enabling bidding.

Hamor, U.S. Pat. No. 8,504,467 discloses a method for online biding for services. These goods and services are published in a listing on a system website, where users may proffer bids for the respective good or service. A predetermined price for the good or service is set, though not disclosed to participants. Once a bidding user reaches the predetermined price, the good or service is successfully purchased by the user. Hamor does not disclose the steps of reviewing user accounts for fraud prior to enabling auction participation, nor does it require any authentication in order to collect the good or service.

Avital, U.S. Patent No. 2006/0242053 discloses a system and method of auctioning participation in activities between users. The activities have predetermined temporal components established by the posting user. This user publishes a notice for an activity he or she would like to engage in with another user and solicits bids for the opportunity to participate. Other users proffer bids in an attempt to secure participation in the activity with the publishing user. The publishing user can then select from the bidding users, thereby determining the winner of the auction. The activities are all real-time offline experiences. Unlike Avital, the present invention reviews the profiles of its users prior to permitting use of the auction system, thereby reducing fraud and promoting trust between users.

These prior art devices have several known drawbacks. They do not disclose any methods of reviewing or vetting participants prior to the establishment of an auction for a multimedia interactive session, and prior to the beginning of a resultant interactive session. It substantially diverges in design elements from the prior art and consequently it is clear that there is a need in the art for an improvement to existing activity auction methods. In this regard the instant invention substantially fulfills these needs.

### SUMMARY OF THE INVENTION

In view of the foregoing disadvantages inherent in the known types of methods of auctioning interactive sessions now present in the prior art, the present invention provides a new identity reviewing methods wherein the same can be utilized for providing convenience for the user when auctioning online activity sessions with celebrities.

The present invention is method of auctioning a digital multimedia interactive session with a celebrity or famous figure. The method accommodates both celebrities interested in donating their time to a charitable cause, and those paid by a commercial business to participate in a promotion. In practice the celebrity may contact the charity or business to initiate the auction. Alternatively the requesting company or charity may solicit the celebrity's participation in a planned auction event. In either instance, a time and duration for the multimedia chat session is decided upon. Discussion topics or themes may also be determined prior to implementation of the auction.

Minimizing the potential for fraud is a key objective of the present method. The first step taken in furtherance of this goal is to require the celebrity to create a user account, which may have a specialized status, e.g. a celebrity user account. During the account creation process, the celebrity is required to record a live video of predetermined length, using an audio-video capture device associated with the person's computing device. This step may be facilitated by software embedded within the website, which checks for operable communication with an audio-video capture device and initiates recording. The resultant multimedia file is sent, along with the celebrity's submitted biographical data, to a system administrator for review. The review process includes comparing the video against known audio-video clips and still images of the celebrity, listening for proper vocal intonation and language use. Once the system administrator is satisfied that the celebrity is the person they claim to be, the account is finalized and the celebrity is notified of successful completion.

Information regarding the multimedia chat session, the celebrity participating and auction information is then posted to the sponsoring organization's website. At the designated time, the auction is started and members of the online community can bid for the chance to participate in the multimedia chat session with the celebrity. At the end of the auction, both parties are notified of the results and sent instructions for attending the session. Prior to the chat session, both parties must submit a captured live video introducing themselves. The content of this video is reviewed by system administrators for appropriateness and compared against information already on file to further confirm the user's identity. In this way, the method reduces the risk of fraud from persons pretending to be celebrities, and also reduces the chance that a celebrity will be harassed during chat session, by taking substantial information, visual records, and audio records from the participant prior to permitting chat entry.

It is therefore an object of the present invention to provide a new and improved multimedia interactive session auction methods that has all of the advantages of the prior art and none of the disadvantages.

It is another object of the present invention to provide a method of auctioning an interactive experience.

Another object of the present invention is to provide an auction method that reduces the risk of fraud by either party.

Yet another object of the present invention is to provide celebrities with a method for reaching out to their fans, while effectively reducing the likelihood that the celebrity will be harassed during the interaction.

Still another object of the present invention is to facilitate capital generation using celebrity interactions.

A further object of the present invention is to provide a safe means for facilitating topical discussions between parties.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general system diagram of an exemplary implementation of the auction method.

FIG. 2 shows a flow chart of account creation prerequisite to auction participation.

FIG. 3 shows a flow diagram of account approval prerequisite to auction participation.

FIG. 4 shows a flow diagram of the introductory multimedia file approval process prior to auction participation.

FIG. 5 shows a flow diagram of the auction initiation process.

FIG. 6 shows a flow diagram of the multimedia interactive session initiation.

### DETAILED DESCRIPTION OF THE INVENTION

Reference is made herein to the attached drawings. Like reference numerals are used throughout the drawings to depict like or similar elements of the method of auctioning a digital multimedia interactive session. For the purposes of presenting a brief and clear description of the present invention, the preferred embodiment will be discussed as used for auctioning an interactive chat session with a celebrity or other famous figure. The figures are intended for representative purposes only and should not be considered to be limiting in any respect.

The method discussed herein provides means auctioning an interactive multimedia session with a celebrity figure. System administrators review the user accounts of all chat participants during the account generation process, thereby reducing the risk of fraud during interactive sessions. The invention accomplishes this by incorporating a requirement for the live capture of a video during the account generation process, and then subjecting the resultant multimedia file to scrutiny by system administrators. By reviewing submitted multimedia files to ensure that they are appropriate in nature and the depicted user appears to be the same as the person described in corresponding biographical data, system administrators can parse out accounts that are clearly deceptive. Further, the method provides for obtaining a permanent video record of community participants. The process reduces the creation of accounts that are visibly fraudulent, such as those purporting to be held by celebrities, or those pretending to be an age or gender other than their own. Integrity of interactions between users is protected by thus removing predators and con artists from the pool of potential chat participants. In this manner, chat participants bid with confidence that celebrity chat participants are who they claim to be.

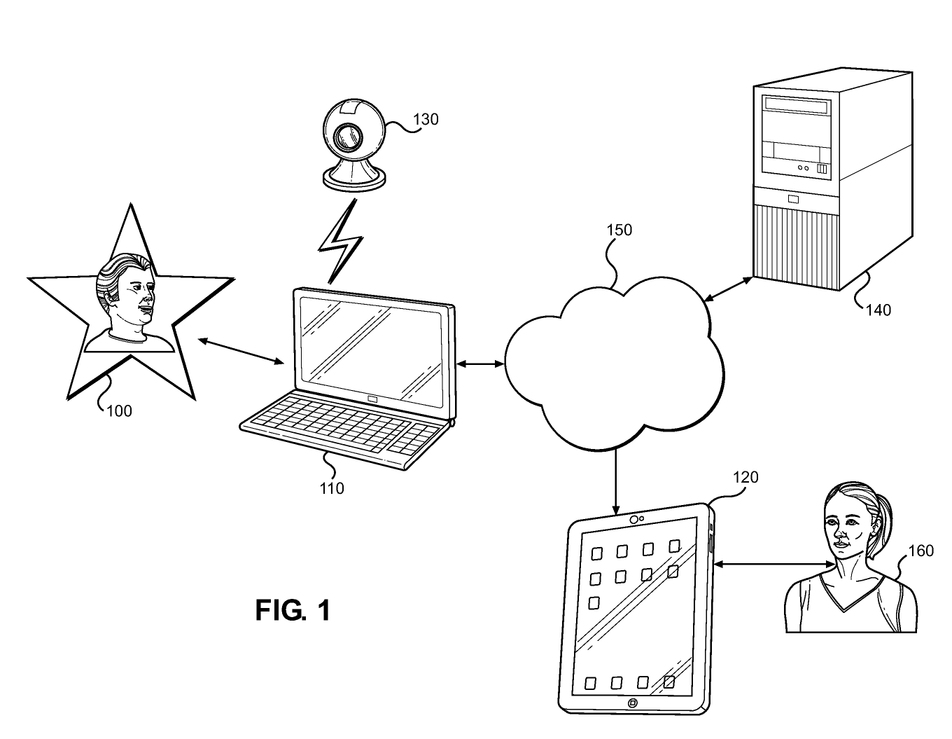

Referring to FIG. 1, there is shown an exemplary implementation of a network environment conducive to use of the present method. Multiple users 100 may access the network environment simultaneously. One or more client computing devices such as a laptop 110, tablet computer 120, smart phone, or desktop computer (hereinafter referred to generally as “client”) is in communication with at least one server 150 via a network 140. Each client is operatively and electrically connected to a text input means and a web-camera or other audio-video capture device 130. The use of the terms “client and server” in the singular is not intended to limit the method to a single client or single server embodiment. During the practice of the method, the network environment may include any number of client computing devices in communication with any number of servers over the network. Similarly, multiple networks may be employed to connect groups of servers or groups of client computing devices together, thereby creating sub-networks. In general, the term network is intended to refer to the “Internet”, but wide area networks (WAN) may also be used, and it will be understood by one of ordinary skill in the art that the method is not limited to implementation on only this network.

Each client and server is implemented as a computing device having a system bus in communication with at least the components of: a central processing unit; a main memory; a storage memory; an input/output (I/O) controller; display devices; and a network interface. An operating system and various software routines are stored on the storage memory. Input/Output devices such as a keyboard, touchpad, touchscreen, mouse, speakers, and the aforementioned audio-video capture device may be connected to the I/O controller. Of these devices only a text input means and, pointer device, and audio-visual capture device are necessary for the implementation of the present invention. Audio output via speakers is also desirable but is not required. The addition of further components or substitution of different configurations of a component will be known to one of ordinary skill in the art and are not enumerated in detail herein.

Each of said servers may run an application stack comprising but not limited to web servers, file upload/download servers, associated databases, and authentication applications. The upload/download server and databases may be integrated with the web server application. A web server includes sub-applications for hosting a website and providing client-side services, as well as facilitating client access to said one or more databases. It is preferable that document-oriented databases capable of indexing, sorting, and querying multimedia files be used in the implementation of the present method. Selected databases should be scalable to avoid limitations on effectiveness of the method. Partitioning strategies such as database sharing may be implemented to promote greater scalability. Clients can access these databases via a website hosted on said web server, pending successful login with the authentication application. Authentication may consist of password checking, credential verification, or confirmation of other identifying information.

In addition to storage of multimedia files, and one or more databases, the one or more servers shall also run a webserver to host an online portal such as a website (hereinafter referred to as “website). Implementation of the online portal is not limited to a particular language, client browser configuration, or design. It is preferable that the online portal is implemented using JAVA (Oracle Corporation of Redwood, Calif.) and Flash (Adobe Systems, Inc. of San Jose, Calif.). Other languages and web-based software applications may be substituted as needed by one of ordinary skill in the art to accomplish the steps described herein.

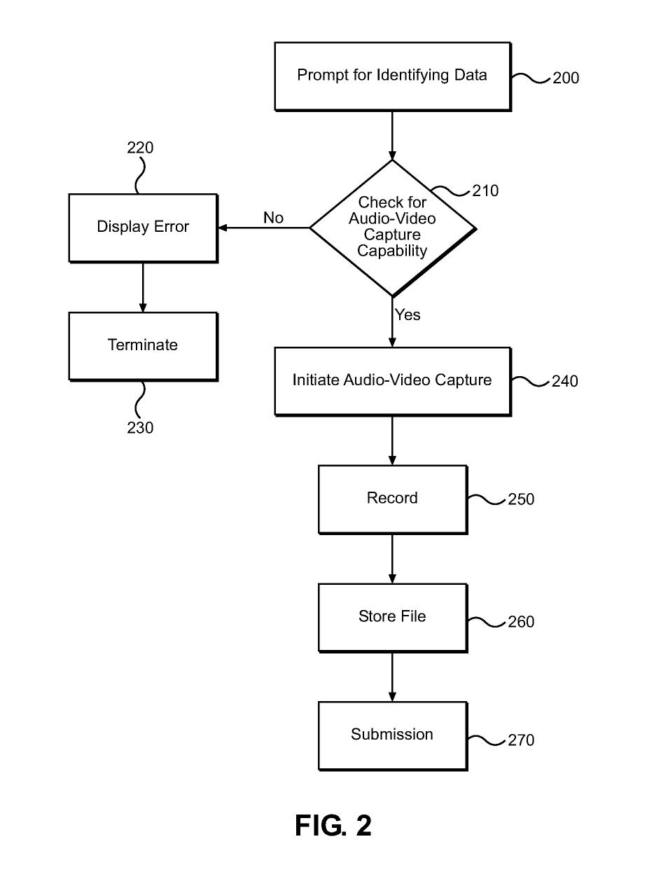

Referring now to FIG. 2, there is shown a diagram of the account creation process. To begin the process a client accesses the web site hosted on the web server. The potential user then interacts with an on-screen indicia presented via a web page, which is displayed in a client web browser. Examples of appropriate indicia are textual links stating, “sign up, and buttons marked “create an account.” Interaction with the indicia results in the display of a prompt for the user to input identifying data 200. This prompt may be in the form of a new webpage, series of pop-up or overlay windows within the web browser. By way of example, a series of fields with textual prompts indicating the information to be entered into field may be displayed to the user. During this input process, users may have access to a link, pop-up window, or other notification means that provides information regarding a pre-determined set of use rules, which regulate the content of multimedia files.

Next, the web server accesses the client machine over the network and checks for an audio-video capture device in operative connection with the client I/O controller 210. Audio-video capture is an essential component of the present process, because multimedia file contents are reviewed by system administrators for signs of fraud. If the result of the capture device check is negative, an error message is displayed 220 to the user via the client screen and the process is terminated 230.

An audio-video capture device check that confirms an operational audio-video recording device returns a positive result to the server. The web server then communicates with the client machine, signaling the beginning of audio-video capture 240. Optionally, the capture may be preceded by an on-screen prompt indicating that a user should confirm their readiness to begin audio-video capture by interacting with indicia. Upon receipt of the communication from the server, the client computing device signals the I/O controller to initiate recording via the audio-video capture device 250. Recording continues for a predetermined period of time established by system administrators. A recording termination communication is sent to the client by the server at the end of the predetermined recording period, or at a time slightly preceding the end of the predetermined time interval. The client receives this termination communication and signals the I/O controller to cease recording.

Transmission and storage of captured audio-video 260 may be accomplished through several methods. In some embodiments, captured data is streamed over the network to the server for storage, during the capture process. Streamed data is received and stored on the server and indexed within the database. Alternatively, in other embodiments, captured data is stored locally on the storage memory and transmitted to the server upon completion of the capture process. In either embodiment, the resultant multimedia file is stored on the server and indexed within one of said databases. The database may be a separate structure designated for account generation request information, or alternatively, the information may be incorporated into a general user database.

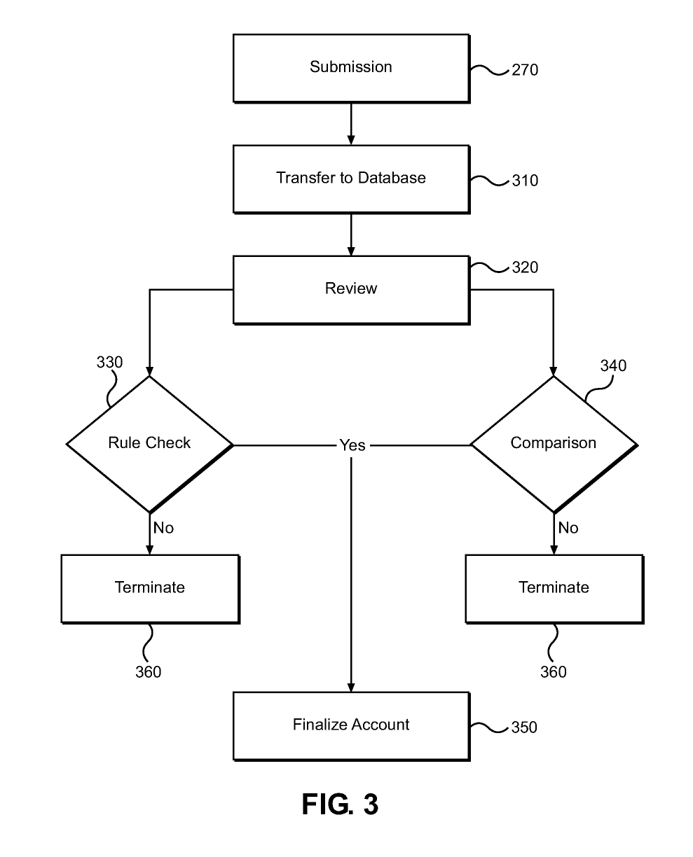

In some embodiments, a user is provided with an opportunity to review the captured video file prior to submission. The multimedia file may be played back in a web browser window and a user prompted for their approval of the captured clip. If the user does not approve the video, the audio-video capture process may repeat until the user is satisfied with the multimedia file produced. Alternatively, the initially captured audio-video file may be stored without prompting the user for his or her approval. In either embodiment, the process is not completed until submission of the input data and multimedia file 270. The account generation process is further depicted in FIG. 3. Upon submission the information and multimedia file are indexed within the database 310 and an identifier added, which indicates that the account is pending review.

Once submitted, requests are reviewed by a system administrator, who can approve or deny the request. Pending finalization of an account, the requesting user does not have access to web server services beyond those available to the general public. Private web services, upload/download server access, and database access are inaccessible to persons without finalized accounts.

System administrators view submitted account generation requests via an administrator portal that is preferably integrated into the web site running on the web server. Data input by the user is visible to a system administrator via the administrator interface along with the submitted multimedia file. Review of the requested account 320 comprises a two-part check of the submitted data and content. If both checks return positive results then the account is approved and finalized 350.

In some embodiments, the first check performed is a check for appropriateness of content 360. To reduce the inadvertent exposure of web site users to erotic, mature, or offensive content, the multimedia file captured during creation of the account generation request is reviewed to verify that it contains appropriate content 330. This review maybe a visual review of the multimedia file in which a reviewing administrator watches the entire length of the file playback. If the file contains material that is not in compliance with the pre-determined use rules, the administrator terminates the account generation process 360. It is preferred that termination results in the transmission of an e-mail, text, or other notification message to the user. The message may address the reasons for request denial, or may simply state that the request did not comply with the use rules.

In some embodiments, a comparison check is the first check performed. The order and duration of the comparison check 340 and appropriateness check 330 is immaterial, so long as each step is performed prior to finalization. Comparison checks may be performed by a system administrator viewing and listening to the multimedia file, or alternatively may be performed by facial recognition software scanning the multimedia file. The contents of the filed are compared against the submitted biographical data to discover any inconsistencies. By way of example, biographical data listing a female of 30 years should match the person depicted in the multimedia file. If the biographical data does not match the depicted person, the administrator terminates the approval process 360. In embodiments incorporating facial recognition software, a failed comparison returns an error to the administrator who then terminates the process. Positive matches from either a manual or automated comparison check results in a prompt for the administrator to finalize the account 350.

Once the account is finalized, the user is notified via e-mail, text, or other notification message and access privileges are assigned. The user can then access some restricted portions of the website, upload multimedia files and participate in web site services. By way of example the multimedia chat becomes accessible to regular users and auction creation is opened to celebrities, once their accounts are approved. User sign-in via the authentication application may be required in order for a user to gain access to the aforementioned services.

In a preferred embodiment, creation of multimedia chat session auctions is initiated by the celebrity user. Though the business or charity may approach the celebrity with the idea of reaching out to fans through a chat auction, it falls to the celebrity to start the auction. The auction creation process is illustrated in FIG. 5. To begin the process, the celebrity accesses his or her user account 510, by signing in to the web server via the authentication application. Next the celebrity user accesses an auction specific portion of the web site. Optionally, this auction specific web page may not be accessible to regular users. Celebrity users can manage their upcoming interactive sessions, check on current auctions and create new auctions via this interface. Display of currently scheduled chat sessions and auctions is accomplished via query of the one or more databases for system events related to the celebrity user, or an associated user identifier.

Auction creation process continues when the celebrity user interacts with indicia displayed on the auction specific web page. Graphic images, textual links are examples of indicia that may be displayed. A number of option fields are displayed to the celebrity user, who then fills in the fields and/or selections auction options 520. Auction options include but are not limited to the date and time of the proposed chat session; duration of proposed chat session; theme of discussion; and any off-limits topics. Once basic options are selected, the celebrity user is then prompted to set auction bidding options 530. Bidding options include but are not limited to silent auction or live auction, starting bid price, bid increment amount, and currency. Taken as a whole, the selection of auction and bidding options creates an auction request.

Auction requests are submitted 540 by the celebrity user to system administrators for review. Submission of the request entails the creation of appropriate entries within the one or more databases, for example an auction database. A flag is added to the database entries to signify that the request is pending. System administrators review the request to ensure that all options are selected, themes are appropriate, and duration of proposed chat session is sufficient. If the system administrators approve the request then they signal the system to begin the auction. The basic implementation of an auction system is known in the art of web development and will be known to one of ordinary skill in the art. For this reason, the details of a specific implementation of an auction application are not discussed herein.

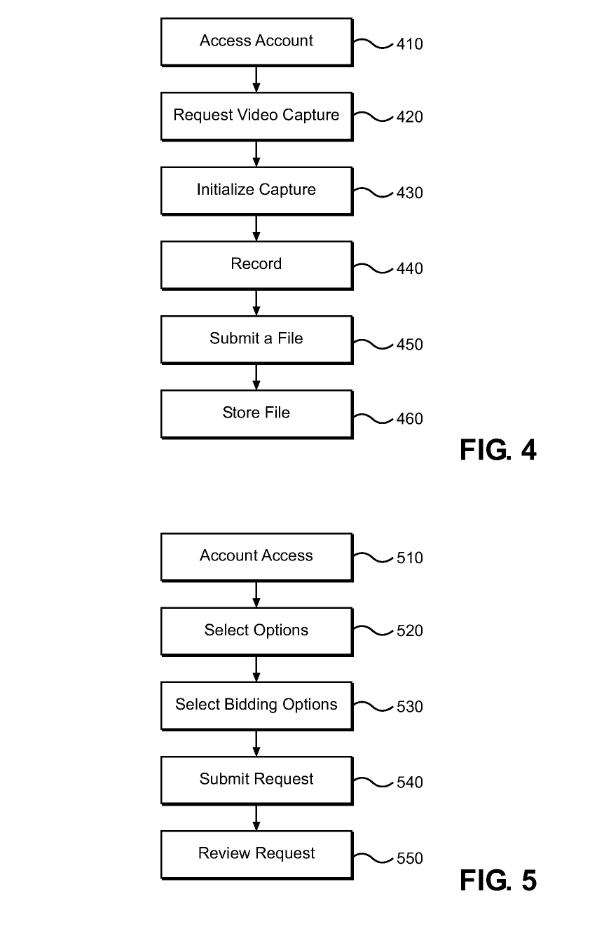

Turning now to FIG. 4 there is shown a second video capture method, resulting in the capture and storage of an introductory multimedia file. While the capture of a second live video is optional, it is a preferred aspect of the present invention because it provides extended auditory and visual evidence of the user. Multimedia files captured during account creation preferably have short duration, making them easy to review, and minimizing the space they take up on a server storage memory. The account generation multimedia file may have the audio stripped to further reduce storage needs. Conversely, the introductory multimedia file has an extended duration and includes audio. In this manner, the user can introduce themselves and offer a description. Duration of this video may be significantly longer than that of the account generation video. The purpose of this video is to provide evidence to other community users regarding the posting user. Thus, the first captured multimedia file is used to assist system administrators corroborate user information, while the introductory multimedia file is used to assist other users with corroboration.

Introductory video capture begins when a user accesses their account 410 via the authentication application, and requests video capture 420. This request may be made by interaction with an on-screen indicia displayed on the user's account web page. Capture is initiated 430 when the server transmits an initiation request to the client over the network. The client I/O controller then signals operatively connected audio-video capture device to begin recording. Recording 440 continues until the user is done speaking and ends recording. Again, an on-screen indicia may be used as a catalyst to cease recording. A termination request is sent to the client device, which then ceases recording, thus ending the recording process. The user can review playback of the multimedia file prior to submission 450. Submitted introductory multimedia files are transmitted and stored 460 on the server in the same manner as those multimedia files captured during account generation.

In some embodiments, submitted introductory videos are reviewed for appropriateness of content, in much the same manner as account generation multimedia files. This reduces the risk that users will add inappropriate material to their video collection after generating an account. Users may add a number of multimedia files to their user account. These files are posted to the user's personal profile web page, where other users can view them.

In some embodiments the presence of an approved introductory video is necessary for participants in a celebrity chat session. Both the celebrity user and the regular user must have approved introductory videos prior to entering the multimedia interactive session. By requiring the users to provide lengthier videos, introducing themselves vocally, the system provides chat participants with a means to familiarize themselves with the people with whom they will chat. This improves trust amongst participants, and further reduces the risk of fraudulent celebrity participation by giving the paying user a chance to check for fraud.

Active auctions may be displayed on the web site hosted by the web server. Bidding users should be required to have a credit card or bank account on file, to ensure payment of winning bids in a timely manner. Users may continue bidding until the auction is over.

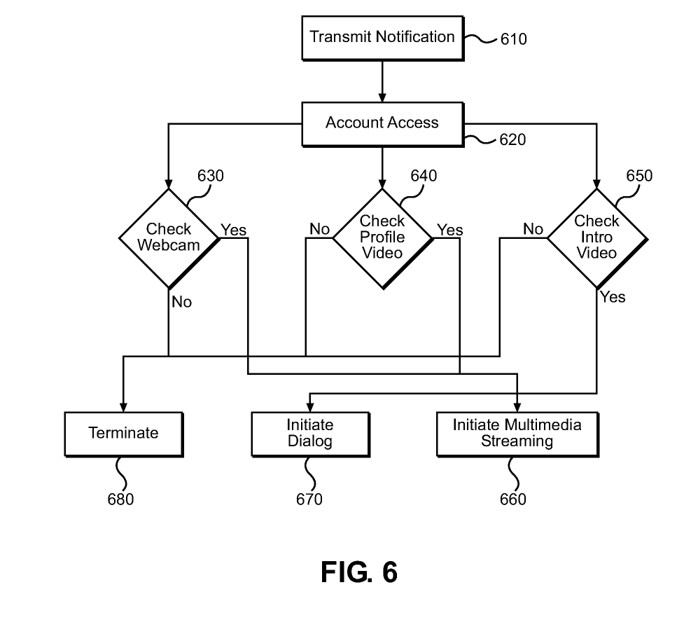

Post auction chat commencement between the celebrity user and the winning bidder is shown in FIG. 6. After the end of an auction, the winning bidder is notified 610 and payment is processed. The user then accesses his or her account via the authentication application 620. At or just before the scheduled session time, specialized indicia may be displayed to authenticated participants. Interaction with the indicia results in a set of checks by the web server. A first check may be a check for an active audio-video capture device 630 in operative communication with the I/O controller of a client. The second check queries the one or more databases for the presence of an approved profile video 640, thereby ensuring that the chat participant is an approved user. An optional third check may consist of a check for an approved introductory multimedia file 650. If both checks return positive results then the participant is placed in the chat session. When all participants are present, an audio-visual chat with textural dialog can commence 670, 680, utilizing the audio-video capture devices and input devices of each participant. If the checks return negative results then the chat session terminates 660 and an error message is displayed.

The method as described above increases trustworthiness of online celebrity interactions with potential users by requiring that they provide an audio-video clip of themselves prior to gaining access to a website and prior to establishing an auction. Persons creating accounts under false identities are parsed out of the potential user pool during the review process. Community users can thus interact with celebrity users with reduced concern about fraud.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A method of generating user accounts in a digital system, comprising the steps of:
prompting a user to input personal information;
checking for the presence of an audio-video capture device in operative communication with a user's computing device, wherein a lack of audio-video capture device results in termination of said method;
initiating capture of a multimedia file of said user;
recording said multimedia file for a pre-determined period of time;
storing said multimedia file;
submission of an account generation request comprising said personal information and said multimedia file by a user;
reviewing said account generation request for compliance with a predetermined rule set, and comparing playback of said multimedia file with said personal information for inconsistencies, wherein failure of said multimedia file to comply with said rule set or match said personal information results in termination of said method;
finalizing a user account based upon said personal information and said multimedia file;
initiating an auction for a multimedia interactive session upon interaction by a celebrity user with an on-screen indicia;
displaying a set of auction options and bidding options to said celebrity user;
selecting from a set of auction options;
selecting from a set of bidding options;
submitting selected auction options and bidding options to a system administrator for review, wherein said submitted options comprise an auction generation request;
reviewing said auction generation request;
launching an auction including said auction options and said bidding options, wherein said auction runs for a pre-determined period of time;
determining an auction winner, wherein said auction winner is a user;
initiating a multimedia interactive session between said celebrity user and said auction winner.

2) The method of claim 1, wherein said step of prompting a user further comprises displaying a series of prompts on a screen of a user's computing device.

3) The method of claim 1, wherein said step of initiating capture further comprises the steps of:
transmitting an audio-video capture initiation signal from a server over a network to said client computing device;
receiving said audio-capture transmission signal by said client computing device;
activating said audio-video capture device.

4) The method of claim 1, wherein said pre-determined period of time is set by a system administrator.

5) The method of claim 1, wherein said step said recording of said multimedia file is terminated upon receipt by said client computing device of an audio-video capture termination signal sent by a server over a network.

6) The method of claim 1, wherein said step of storing said multimedia file comprises transmission of said file to a server having a storage memory upon which said multimedia file is stored.

7) The method of claim 1, wherein said step of submission of said account generation request further comprises the steps of:
indexing said personal information and said multimedia file within a database; and
denoting said personal information and multimedia file with an identifier to indicate that review is pending.

8) The method of claim 1, wherein said step of reviewing is performed by a system administrator manually reviewing multimedia file playback.

9) The method of claim 1, wherein said step of reviewing is performed by software adapted to perform facial recognition.

10) The method of claim 1, wherein said auction options comprise a type of auction, duration of multimedia interactive session, date of multimedia chat session.

11) The method of claim 1, wherein said bidding options comprise a starting bid amount, a bid increment amount.

12) The method of claim 1, wherein said step of submission of said auction generation request further comprises the steps of:
indexing said auction generation request within a database; and
denoting said auction generation request with an identifier to indicate that review is pending.

13) The method of claim 1, wherein said step of determining said auction winner comprises determining the highest bid amount.

14) The method of claim 1, wherein said step of initiating said multimedia interactive session occurs at a date and time corresponding to said selected auction options.

15) The method of claim 1, further comprising the steps of:
querying a database for the presence of an introductory multimedia file associated with said user, wherein failure to return a positive result results in termination of said method.

16) The method of claim 15, wherein said introductory multimedia file a live captured video created after said step of finalizing said user account.

17) The method of claim 16, wherein said introductory multimedia file is reviewed for appropriateness.
